(19) United States
(12) Patent Application Publication
(10) Pub. No.: US 2017/0341954 A1
(43) Pub. Date: Nov. 30, 2017

(54) URANIUM CAPTURE ON INORGANIC-ORGANIC GRAPHITE-BASED HYBRID MATERIAL: ADSORBENT MATERIAL FOR MINING RECLAMATION AND DOMESTIC WATER USES

(71) Applicant: New Mexico Tech Research Foundation, Socorro, NM (US)

(72) Inventors: Liliya Frolova, Socorro, NM (US); Samantha V. Saville, Bend, OR (US); Snezna Rogelj, Socorro, NM (US)

(21) Appl. No.: 15/604,494

(22) Filed: May 24, 2017

Related U.S. Application Data
(60) Provisional application No. 62/340,943, filed on May 24, 2016.

(51) Int. Cl. C02F 1/28; B01J 20/30; B01D 15/22; B01J 20/22; G21F 9/12; C02F 101/00; C02F 101/10; C02F 101/20

(52) U.S. Cl. CPC C02F 1/28; B01J 20/22; B01J 20/3085; G21F 9/12; B01D 15/22; C02F 2101/103; C02F 2101/20; C02F 2101/006

(57) ABSTRACT

The present invention provides compositions for removal of arsenic or heavy metal contaminants in the process of fluid filtration comprising an organically modified inorganic adsorbent, wherein the composition is produced by reaction with 1,3-dipolar compounds prior to filtration. Also provided are systems for fluid filtration, comprising compositions as provided herein, in a column or column-like format, wherein a fluid is provided to the column such that the fluid flows through the organically modified inorganic adsorbent, and wherein contaminants present in the fluid are bound to the composition. Additionally provided are methods for fluid filtration, comprising contacting a fluid sample with the composition of claim 1 and collecting the filtered fluid sample after filtration.

### RELATED APPLICATION

This application claims priority to U.S. Provisional Patent Application No. 62/340,943, filed May 24, 2016 and entitled “Uranium Capture on Modified Inorganic-Organic Graphite Hybrid Material to Develop a Specific Uranium Binding Filtrate Material for Mining Reclamation and Domestic Water Uses.” The complete disclosure of the above-identified priority application is hereby fully incorporated herein by reference.

### STATEMENT REGARDING FEDERALLY SPONSORED RESEARCH

This invention was made with government support under grant number IIA-1301346 NSF granted by the New Mexico EPSCoR Program Uranium Transport and Site Remediation. The government has certain rights in the invention.

### TECHNICAL FIELD

The subject matter disclosed herein is generally directed to materials and methods for fluid filtration. Specifically, the present disclosure is related to removal of contaminants from fluid samples, such as water.

### BACKGROUND

Uranium is a prominent contaminant in the Southwest. The peak production of uranium was in the 1950s with over 250 mines in operation. Since then, there has been a pronounced decrease in uranium production in the United States and most uranium is now imported. Today there are less than 15 uranium mines in operation across the United States. Many places that have uranium contamination, either by natural uranium sources or mine-waste runoff, do not have the financial capacity or accessibility to electricity required to utilize current filtration systems. The current filtration option most feasible for domestic water systems, the ion exchange approach, is not specific for uranium, so when competing ions like calcium and magnesium are also present, the filter material may not capture uranium. Furthermore, currently available systems are highly pH dependent. New materials selective for uranium adsorption, with durability under many different conditions, reusability, and long life span would be beneficial for small water systems, individual homes, as well as for uranium reclamation purposes.

### SUMMARY

In one aspect, the invention provides a composition for fluid filtration comprising an organically modified inorganic adsorbent, wherein the organic modification of inorganic adsorbent is produced by reaction with one or more 1,3-dipolar compounds prior to filtration. In one embodiment, the inorganic adsorbent comprises graphite, silica, alumina, titanium oxide, or transition metal particles. In another embodiment, the contacting produces the organically modified adsorbent after reaction with the one or more 1,3-dipolar compounds prior to filtration. In another embodiment, the one or more 1,3-dipolar compounds comprise azomethyn ylides, nitrile ylides, carbonyl ylides, or thiosulfines. In a further embodiment, the organically modified adsorbent is washed over a filter and then dried overnight, or used immediately. In another embodiment, the organically modified adsorbent is washed with one or more different organic and inorganic solvents. In a still further embodiment, the composition adsorbs contaminants in a fluid sample to remove the contaminants from the sample, or the fluid sample is water and the contaminant is a heavy metal or arsenic. In some embodiments, the heavy metal comprises uranium, vanadium, iron, zinc, strontium, tin, palladium, copper, silver, gold, or barium. In some embodiments, the fluid sample is drinking water, seawater, or freshwater, or the fluid sample has an acidic pH, a basic pH, or a neutral pH. In other embodiments, the composition binds to the heavy metal or arsenic with high selectivity independent of pH of the fluid sample, or the composition binds to the heavy metal with greater selectivity than other compounds or elements present in the fluid sample.

In another aspect, the invention provides a system for fluid filtration, comprising the composition of claim 1, wherein the composition binds to contaminants in a fluid sample to remove the contaminants from the sample. In one embodiment, the fluid is water and the contaminant comprises uranium, vanadium, iron, zinc, arsenic, strontium, tin, palladium, copper, silver, gold, or barium. In another embodiment, the fluid sample is drinking water, seawater, or freshwater, or the fluid sample has an acidic pH, a basic pH, or a neutral pH. In another embodiment, the composition binds to a heavy metal independent of pH of the fluid sample.

In another aspect, the invention provides a method for fluid filtration, comprising: contacting a fluid sample with the composition of claim 1; and collecting the filtered fluid sample after filtration. In one embodiment, the composition is contained within a column or column-like format, or a sequential series of columns. In another embodiment, the composition binds to contaminants in a fluid sample to remove the contaminants from the sample. In further embodiments, the fluid sample is water and the contaminant comprises uranium, vanadium, iron, zinc, arsenic, strontium, tin, palladium, copper, silver, gold, or barium, or the fluid sample is drinking water, seawater, or freshwater, or the fluid sample has an acidic pH, a basic pH, or a neutral pH. In a still further embodiment, the composition binds to a heavy metal independent of pH of the fluid sample.

### BRIEF DESCRIPTION OF THE DRAWINGS

FIG. 1—Shows the structure of graphite.

FIG. 2—Shows the average percent adsorption and repeatability of natural samples adsorbed to CM1 500. All experiments were performed in triplicate or sequentially performed three times and all have standard deviations even though an error bar is too small to appear on the graph.

FIG. 3—Shows an example of a structure of humic acid.

FIG. 4—Shows the adsorption capacity for CM1 (14).

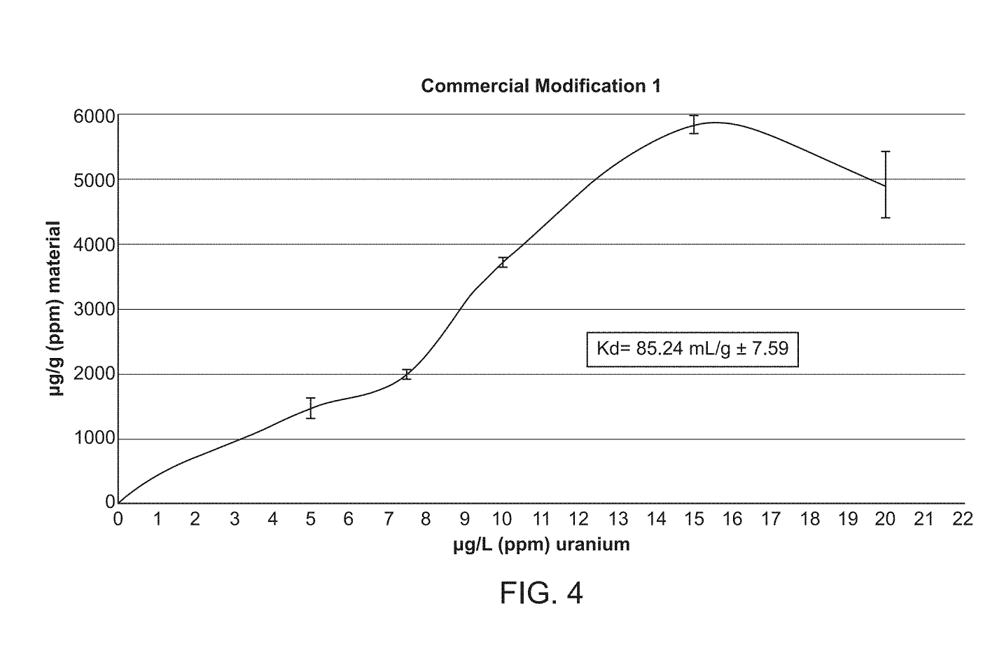

FIG. 5—Shows SEM pictures of before (A) and after filtration (B) of starting commercial material SM, before (C) and after (D) filtration of organically modified commercial graphite CM1.

### DETAILED DESCRIPTION OF THE EXAMPLE EMBODIMENTS

Unless defined otherwise, technical and scientific terms used herein have the same meaning as commonly understood by one of ordinary skill in the art to which this disclosure pertains.

As used herein, the singular forms “a,” “an,” and “the” include both singular and plural referents unless the context clearly dictates otherwise.

The term “optional” or “optionally” means that the subsequently described event, circumstance or substituent may or may not occur, and that the description includes instances where the event or circumstance occurs and instances where it does not.

The recitation of numerical ranges by endpoints includes all numbers and fractions subsumed within the respective ranges, as well as the recited endpoints.

The terms “about” or “approximately” as used herein when referring to a measurable value such as a parameter, an amount, a temporal duration, and the like, are meant to encompass variations of and from the specified value, such as variations of +/−10% or less, +/−5% or less, +/−1% or less, and +/−0.1% or less of and from the specified value, insofar such variations are appropriate to perform in the disclosed invention. It is to be understood that the value to which the modifier “about” or “approximately” refers is itself also specifically, and preferably, disclosed.

Reference throughout this specification to “one embodiment,” “an embodiment,” “an example embodiment,” means that a particular feature, structure or characteristic described in connection with the embodiment is included in at least one embodiment of the present invention. Thus, appearances of the phrases “in one embodiment,” “in an embodiment,” or “an example embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the invention. For example, in the appended claims, any of the claimed embodiments can be used in any combination.

All publications, published patent documents, and patent applications cited in this application are indicative of the level of skill in the art(s) to which the application pertains. All publications, published patent documents, and patent applications cited herein are hereby incorporated by reference to the same extent as though each individual publication, published patent document, or patent application was specifically and individually indicated as being incorporated by reference.

### Overview

The present invention provides compositions for fluid filtration comprising inorganic substrates modified by 1,3-dipolar molecules. Such compositions can be provided in a system for fluid filtration, as described in detail herein. Also provided are methods for fluid filtration using such compositions. Compositions and methods as provided by the present invention will find use in, for example, water purification systems for removing contaminants such as uranium.

Uranium is the most abundant of the actinide elements, averaging 1.2 to 1.3 μg/g in sedimentary rocks, up to 15 μg/g in granites, and up to 120 μg/g in phosphate-containing rocks (3). In sea water, uranium can range from 2 to 3.7 ppb (μg/L). In streams in the United States, there is usually between 0.1 and 7 ppb, although in the southwestern U.S., it can range as high as 20 ppb due to irrigation return-flows and evaporative concentration (3). The Environmental Protection Agency in 1991 proposed the uranium standard for drinking water to be maximally 30 ppb (4). Most surface water in the United States is below this level. Groundwater in uranium-rich areas can range up to 120 ppb, four times the drinking water limit (3). In uranium mine runoff water, it can range up to 400 ppb (5), whereas the leachates for mines and mills can contain up to 20 ppm (mg/L) uranium (6).

Uranium usually forms small ore bodies, which require a large amount of exploration to locate deposits (2). One of the largest deposits in the United States is in Grants, New Mexico, with 45,000 tons of U₃O₈, a size that is small compared to the largest known deposit of 2×10⁵ tons (2).

Uranium tends to form three major oxidation states U(IV), U(V), and U(VI). Uranium (IV) is the main oxidation state of uranium ore minerals like uraninite (U₃O₈) and coffinite (USi0₄) (7) and tends to form an insoluble oxide in water (8). The major complexes of uranium in water are predominantly in low electron potential groundwater, but it is usually in minimal concentrations due to the poor solubility of these complexes (3). Uranium (V) tends to form the UO₂⁺ ion in acidic pHs and medium oxidation potentials; this is very rare, since medium oxidation potentials are not found in natural systems. This forms weak and unstable complexes compared to the other oxidation states (3). Uranium (V) is therefore rarely found in the natural environment. Uranium (VI) usually forms the uranyl ion (UO₂²⁺) or UO₂OH⁺ in pH below 7, which is highly soluble and is the major component in the transport of uranium in natural systems (3). This is important since, in most natural water systems, the pH will be below 8; thus, uranium will normally be present in a cation form. Uranyl also acts as a strong Lewis acid and has a high capacity to interact with organic and inorganic ligands at various ionic strengths (9). Minerals in this oxidation state are typically formed by weathering of U(IV) minerals or by high concentrations of dissolved U(VI) due to evaporation in arid climates (3). Uranyl forms rare secondary minerals, such as schoepite ((β-UO₃×2H₂O), carnotite (K(UO₂)₂(VO₄)₂), and tyuyamunite (Ca(UO₂)₂(VO₄)₂). These minerals precipitate in low carbon dioxide waters, common in oxidized arid environments including the sandstone-hosted uranium deposits of the southwestern United States (3). Coffinite (USiO₄) mixed with quartz, fine grain uraninite, and some organic material (10), is the main uranium ore mineral found in the southwest, predominantly in the Colorado Plateau region (3).

Uranium is a health concern, as both a source of radiation and as a heavy metal. If uranium in solution enters the body, it acts as a mutagen in the kidney and renal areas of the body. However, the greatest health threat is the fact that uranium (in the divalent cation form) can replace the calcium found in bones (11).

Katsoyiannis (11) reported that different uranium species are found at different pH values. For example, below a pH of 7, the dominant species of uranium is the cationic form. The UO₂²⁺ species is found from pH 1-7 and is the dominant species from pH 1-5; UO₂(OH)⁺ is found from pH 3-8 and is the dominant species from pH 5-7, and (UO₂)₃(OH)₅ is found from pH 6-8 but is never present as a dominant species. At pH values ranging from 5-10 with dominating speciation from pH 7-8, uranium is found in the neutral form, UO₂(OH)₂. At pH values above 7 and dominating from pH 8-10, uranium is found in its anion species of UO₂(OH)⁻ (11).

The present disclosure provides, for the first time, compositions, systems, and related methods based on inorganic substrates modified by 1,3-dipolar molecules for fluid filtration. Particular uses may be water purification, such as for drinking water, or removing or collecting contaminants from mine runoff Particular uses will be apparent in light of the present disclosure, which are described below and exemplified in the Examples.

Current Filter Methods

There are several filtration methods that claim specificity and selectivity towards uranium. The most common of these are anion exchange filters. Other types of filters include reverse osmosis, coagulation techniques, and adsorption techniques.

Anion exchange filters are based mainly on speciation of the uranium and are found to be highly affected by both the type of water they are filtering and the pH. These systems work primarily above pH 6 and have low uranium removal rates when competing ions are present in the system or where precipitates can be formed. When cation exchange is utilized, it is only effective in a pH range of 2.5-3.5 (11).

Reverse osmosis filters and nano filtration techniques have, on average, over 90% uranium adsorption. These filters have been found to work well for concentrations of uranium above 150 ppb but little experimental data are available for lower concentrations of uranium. These filters are also expensive because they need a sediment filter and two carbon filters on either side of the reverse osmosis filter in order to avoid clogging. They also do not selectively filter any particular species, rather, they filter everything from of the water (11).

Coagulation techniques for uranium removal mainly use ferric (Fe³⁺) sulfate and ferrous (Fe²⁺) sulfate as redox reagents. This method is currently used in about 20 water treatment plants, however only two of these report positive uranium removal results. This technique is also not selective to uranium and is extremely pH dependent. Katsoyiannis et al. (11) found that this technique only works at a pH of 6 or 10, but not in the range between them. This is problematic because the pH of most natural waters ranges from 6 to 9 and can vary depending on the season (11).

Adsorption techniques currently available in the industry use iron oxides that are highly effective at pH between 5 and 9. This spans the range of natural water, however it has been found that, in systems with carbonates, uranium removal becomes ineffective (11). This creates a significant problem because carbonates are a common species in water, and uranium binds to carbonates; in the presence of carbonates, therefore, uranium binds very poorly to iron oxides. When using titanium dioxides as the adsorption agent, it does not remove uranium above pH 6, a common pH in natural systems. Veliscek-Carolan et al. (12) studied the effects of adding small organic pendants to titanium oxide for uranium removal. They used a phosphate pendant and found that while non-functionalized titanium oxide selectively adsorbs about 20% of uranium, the functionalized titanium oxide selectively adsorbs around 50% of uranium. This overall low uranium adsorption to thus functionalized titanium oxide is attributed to phosphate's pH dependence, and therefore the loss of phosphate at lower pH's.

### Compositions for Fluid Filtration

In some embodiments, the present invention provides compositions for use in fluid filtration. Compositions as described herein may be in any form useful for filtration or purification purposes, particularly for water purification to remove one or more contaminants. Any contaminant in a water sample may be removed using compositions as described herein, with particular embodiments directed to contaminants such as a heavy metal or arsenic. As used herein, a heavy metal may include, but is not limited to, uranium, aluminum, vanadium, iron, zinc, strontium, tin, palladium, copper, silver, gold, or barium. Any contaminant of a water sample that may be removed according to the present disclosure is within the scope of the invention. In some embodiments, more than one heavy metal may be removed from a sample at the same time. In other embodiments, a composition as described herein may be used in filtration or purification to remove one or more contaminants from a fluid or filtrate by adsorption of the contaminant(s) to the material or a component thereof.

Two main types of adsorbents or filtering materials (i.e., media) are typically employed. These may be surface filters, which are solid sieves that trap solid particles with or without the aid of filter papers, and depth filters, which are beds of granular material that retains solid particles as they pass. Such types of filters may use size differentiation to trap particles, or may bind to a particle of interest.

Compositions as described herein may comprise an organically modified inorganic adsorbent, wherein the organic modification of inorganic adsorbent is produced by reaction with one or more 1,3-dipolar compounds prior to filtration. Such compositions may be prepared from a variety of materials as described herein, including, but not limited to, graphite, silica or silica dioxide, graphene oxide, alumina or alumina oxide, titanium oxide, transition metal particles, or any other type of material known in the art, including any porous materials capable of adsorbing a contaminant. In some embodiments, more than one such material may be combined to produce a composition for optimum filtration as necessary for the particular application. For example, graphite may be combined with titanium oxide in a material to be used for water purification in order to eliminate contaminants that one or the other material would not normally remove alone.

Some embodiments of the invention make use of a novel adsorbent material, exemplified herein by the adsorbent CM1. CM1 material, or any other material appropriate for use with the invention, may be useful for a composition for fluid filtration due to relative independence of pH, and/or for selectivity or specificity for a particular contaminant, such as a heavy metal or arsenic, in any solution, and at any pH. For example, in some embodiments, any type of commercially available graphite or related material, may be modified as described herein for use in accordance with the present invention and are therefore encompassed within the scope of the invention.

Adsorbent or filtering materials of the present invention may be prepared using any appropriate method known in the art. In accordance with the present invention, an appropriate adsorbent material as described herein may be produced by reaction with a 1,3-dipolar organic compound or reagent, for example including, but not limited to, azomethyn ylides, nitrile ylides, carbonyl ylides, and thiosulfines. Non-limiting examples of 1,3-dipolar compounds include, but are not limited to, azomethyn ylides, nitrile ylides, carbonyl ylides, and thiosulfines, although any 1,3-dipolar compounds are encompassed within the scope of the invention. A final inorganic-organic hybrid adsorbent produced by cycloaddition or a cycloaddition reaction may be used as appropriate.

In some embodiments, any 1,3-dipolar organic reagent may be used for preparation of the adsorbent as described herein, with no reduction in the specificity, adsorption, or filtering capacity of the material. In some embodiments, an organic compound such as tetracyanoethylene oxide or other appropriate reagent may be heated, either alone, or in another organic compound or reagent as described herein, for preparation of the adsorbent. Such heating may be performed for any time period appropriate for the particular organic reagent and may vary or be adjusted or optimized for each reagent. For example, 6 hours, 8 hours, 10 hours, 12 hours, 14 hours, 16 hours, 18 hours, 20 hours, 22 hours, 24 hours, 36 hours, 48 hours, 60 hours, or any appropriate length of time desired, to achieve the desired effect. One of skill in the art will understand and be readily able to optimize temperature parameters according to the particular reagent as appropriate in accordance with the invention.

Heating of an organic reagent with inorganic materials such as graphite, silica, alumina, titanium oxide, transition metal particles, or other materials used to prepare the adsorbent may be performed at a temperature of, for example, from about 100° C. to about 200° C., for example, 100° C., 105° C., 110° C., 115° C., 120° C., 125° C., 130° C., 135° C., 140° C., 141° C., 142° C., 143° C., 144° C., 145° C., 146° C., 147° C., 148° C., 149° C., 150° C., 151° C., 152° C., 153° C., 154° C., 155° C., 156° C., 157° C., 158° C., 159° C., 160° C., 161° C., 162° C., 163° C., 164° C., 165° C., 166° C., 167° C., 168° C., 169° C., 170° C., 175° C., 180° C., 185° C., 190° C., 195° C., 200° C., or the like. In some embodiments, any temperatures may be used as appropriate with the invention, and any ranges useful are encompassed within the scope of the invention. Following heating, the organically modified inorganic material, such as graphite or any other material disclosed herein, may be filtrated, washed, and then dried overnight or used without drying. Washing the adsorbent may be performed using one or more different organic and/or inorganic solvents or reagents, including, but not limited to, water, alcohol, acetonitrile, and/or acetone. Drying the modified material may be performed using any appropriate methods.

Inorganic material can range in size from well below 10 μm to well above millimeters in size. In some embodiments, inorganic material as described herein may be any size that is capable of adsorbing or filtering a particle or contaminant of interest, such as 1μm, 2μm, 3 μm, 4 μm, 5 μm, 6 μm, 7 μm, 8 μm, 9 μm, 10 μm, 20 μm, 30 μm, 40 μm, 50 μm, 60 μm, 70 μm, 80 μm, 90 μm, 100 μm, 150 μm, 200 μm, 250 μm, 300 μm, 350 μm, 400 μm, 450 μm, 500 μm, 550 μm, 600 μm, 650 μm, 700 μm, 750 μm, 800 μm, 850 μm, 900 μm, 950 μm, 1 mm, 2 mm, 3 mm, 4 mm, 5 mm, 6 mm, 7 mm, 8 mm, 9 mm, 10 mm, or any size appropriate for use with a desired contaminant. In specific embodiments, as described herein in the Examples, the graphite powder may comprise a particle size of less than about 150 μm. Such a size may be achieved by manual methods, such as hand crushing, or it may be done using a machine. In some embodiments, commercial materials may be used and modified or altered as necessary. In some embodiments, any type of commercially available graphite or starting material disclosed herein may be modified as described herein for use in accordance with the present invention.

As described herein, compositions may be employed to bind to contaminants in a fluid sample, such as a water sample, to remove the contaminants from the sample. In this way, the contaminants are removed from the water samples and the purified sample may be for any appropriate purpose, including, but not limited to, drinking, wastewater treatment, commercial purposes, or the like. In other embodiments, samples that have multiple different contaminants or components present may be analyzed and compared to non-contaminated samples in order to evaluate levels of contamination as a result of wastewater runoff or natural phenomena.

In some embodiments, a fluid sample as described herein may be water, and the contaminant may be one or more of uranium, vanadium, iron, zinc, arsenic, strontium, tin, and barium, other metals. Drinking water is an important consideration for much of the world, and thus particular embodiments of the invention relate to purification of water samples for consumption by humans and animals. In addition, mining runoff, while not widely used in the United States, creates contamination in many environments that would benefit from clean water for any purpose. However, any water sample may be used with compositions as described herein, including drinking water, seawater, or freshwater, although any fluid sample from any source may be used in accordance with the invention and is encompassed therein. In some embodiments, a fluid sample useful with the invention may have an acidic pH, a basic pH, or a neutral pH. As used herein, acidic pH generally refers to a pH less than about 7, and a basic pH generally refers to a pH of greater than 7, with a neutral pH generally referring to a pH of about 7. One of skill in the art will understand the meaning of these terms as appropriate for use with the invention.

The present compositions are able to remove contaminants, such as heavy metals or arsenic from a water sample at different concentrations. A composition as described herein adsorbs or binds contaminants in a fluid sample to remove the contaminants from the sample. Depending on the source, a fluid or water sample may have a higher or lower concentration of a contaminant, for example uranium, and therefore, useful compositions in accordance with the invention may be capable of removing any detectable variety of concentrations. For example, compositions of the present invention may be able to remove uranium concentrations from about 1.2 to about 1.3 μg/g, up to 15 μg/g, up to 120 μg/g, from about 2 to about 3.7 ppb (m/L), between about 0.1 and 7 ppb, up to 20 ppb, up to 120 ppb, up to 400 ppb, or up to 20 ppm, including any concentrations in between these ranges. For drinking water, a sample may be tested in order to ensure that it is in accordance with the proposed guidelines of the Environmental Protection Agency (EPA), which state that drinking water should contain less than 30 ppb uranium (3 mg/L) uranium (6). In some embodiments, the present composition may remove uranium concentrations of from about 1 ppb to about 20 ppm.

Likewise, compositions of the invention may remove some or all of the contaminant in a fluid sample. In specific embodiments, the compositions described herein may remove about 50% of the uranium in a water sample, to all of the uranium in a sample. For example, 50%, 55%, 60%, 65%, 70%, 75%, 80%, 85%, 90%, 95%, or 100% of the uranium present in a water or fluid sample may be removed using the compositions of the present invention. In some embodiments, a composition such as described herein may bind to a contaminant such as heavy metal with high selectivity and/or specificity independent of pH of the fluid sample, or may bind to a contaminant with greater selectivity and/or specificity than other compounds or elements present in the fluid sample. For example, an adsorbent composition as presently described may be used to treat or test natural water samples wherein uranium may be present with other natural elements such that the other elements would for other filtration methods interfere with uranium binding. In this regard, the compositions of the present invention represent an advantage over the art, in that the compositions selectively and specifically bind uranium over other elements, independent of the pH of the solution or sample.

In some embodiments, uranium in a fluid sample such as water may be present in the fluid sample in any form or any oxidation state. For example, uranium may be present as U(IV), U(V), and U(VI). Uranium (IV) may be present as the main oxidation state of uranium ore minerals like uraninite (U₃O₈) and coffinite (USi0₄). Uranium (V) may be present as the UO₂⁺ion in acidic pHs and medium oxidation potentials, or as weak complexes. Uranium (VI) may be present as uranyl ion (UO₂²⁺) or UO₂OH⁺ in pH below 7. In most natural water systems, the pH will be below 8; thus, uranium will normally be present in a cation form. Thus, in some embodiments, the compositions of the present invention may bind to or adsorb uranium in acidic, basic, or neutral fluid samples. Uranyl may be present as rare secondary minerals, such as schoepite ((β-UO₃×2H₂O), carnotite (K(UO₂)₂(VO₄)₂), and tyuyamunite (Ca(UO₂)₂(VO₄)₂). In other embodiments, uranium may be present as coffinite (USiO₄) mixed with quartz, fine grain uraninite, or other organic materials. Uranium may be present as an insoluble oxide. Removal of uranium in any or all soluble forms may be done using the compositions described herein and fall within the scope of the present invention.

### Systems for Fluid Filtration

The invention also provides systems for fluid filtration, comprising a composition such as described herein. In some embodiments, the composition adsorbs or binds to contaminants in a fluid sample to remove the contaminants from the sample. As described in detail above, a fluid sample may be water and the contaminant may be arsenic or a heavy metal, including, but not limited to, uranium, vanadium, iron, zinc, strontium, tin, palladium, copper, silver, gold, or barium. Fluid samples may be drinking water, seawater, or freshwater. Further embodiments provide a fluid sample having an acidic pH, a basic pH, or a neutral pH. In particular embodiments, the composition binds to a contaminant such as a heavy metal or arsenic independent of pH of the fluid sample. As used herein, “independent of pH” may refer to binding or adsorption of a compound of the invention to a contaminant entirely independent of the pH of the fluid sample, or relatively independent of pH, i.e., regardless of the pH of a solution. In some embodiments, the characteristics described above for a composition also apply to a system or related methods comprising the use of such a composition, as would be understood by one of skill in the art.

Such a composition may be provided in a column or column-like format, or may be provided in any other form useful for filtering a fluid sample, such as a filter insert or filter into which a fluid sample is poured for decontamination. Using a system as described herein, a fluid sample is provided to a column or other filter medium such that the fluid flows through the adsorbent material, for example graphite or another organically modified inorganic adsorbent disclosed herein, and wherein contaminants present in the fluid are adsorbed or bound to the composition. Such binding to the composition may be reversible or may be irreversible. For reversible binding, washing or eluting of the contaminants may be performed using chemical reagents or methods in order to clean and/or decontaminate the composition. As described herein, the particles of the composition may be any size as described above. In some embodiments, the size of a particle of a composition as described herein may vary depending on the particular contaminant. For example, some embodiments of the invention may benefit from smaller adsorbent particle size, such as less than about 150 μm. In specific embodiments, a system may comprise a column or column-like format with an adsorbent material as described above. In some embodiments, the column may have additional materials, such as graphite, silica or silica dioxide, graphene oxide, alumina or alumina oxide, titanium oxide, amorphic carbon, transition metal particles, or any other type of material known in the art.

Columns or other filter formats may be assembled using any appropriate methods known in the art. In some embodiments, gravity packing may be useful for use with a composition as described herein. Gravity or column packing is well known in the art and one of skill in the art would be readily able to perform such methods using the compositions of the invention as appropriate.

The amount of a composition to be used in systems or methods of the invention as described herein may vary according to the particular application. In some embodiments, any amount of an adsorbent composition or media may be used, such as 50 mg, 55 mg, 60 mg, 65 mg, 70 mg, 75 mg, 80 mg, 85 mg, 90 mg, 95 mg, 100 mg, 150 mg, 200 mg, 250 mg, 300 mg, 350 mg, 400 mg, 450 mg, 500 mg, 550 mg, 600 mg, 650 mg, 750 mg, 800 mg, 900 mg, 1000 mg, or the like, may be used in a single column. The amount may vary depending on the particular application, or the particular contaminant.

The systems of the invention will bind to a contaminant in a fluid sample, such as a heavy metal, in a water sample, to remove the contaminants from the sample. Any fluid sample appropriate with the invention may be used, including, but not limited to drinking water, seawater, or freshwater. Washing or cleaning of the column may be performed by rinsing with solvents or detergents. For example, chemical cleaning may be performed using organic and/or inorganic solvents such as acetonitrile, ionic detergents, acid mixtures, basic mixtures, salt solutions. In some embodiments, acidified or non-acidified reverse osmosis (RO) water may be used to clean a composition as described herein or to clean a column containing such a composition. Acidified water may be used at any pH, although pH of 1-2 may more quickly rid the composition and/or column of certain elements, such as arsenic or heavy metals including, but not limited to, uranium, vanadium, iron, zinc, strontium, tin, palladium, copper, silver, gold, or barium. In cases where acidified RO water is used, non-acidified water may then be added to the composition or column in order to increase the pH of the adsorbent composition material before introducing another sample to prevent metal species changing in the sample and any possible mischaracterization of the sample.

### Methods for Fluid Filtration

The invention also provides a method for fluid filtration, comprising: contacting a fluid sample with a composition as described herein and collecting the filtered fluid sample after filtration. Such methods may be performed with compositions as described herein in the form of a column or column-like format, or other format, or using other filter media, or combinations of different types of media, as described herein. Columns and filters are well known in the art and one of skill in the art will understand how to perform the methods as described herein using the claimed compositions in a column format. In some embodiments, a composition as described herein may be washed before being contacted with a sample such as a drinking water sample, a seawater sample, a freshwater sample, or any other appropriate sample, may be washed after contacting the sample, or both before and after contacting of the sample and filtering composition. As described above, washing may be performed using chemical reagents or other means in order to clean the column for accurate measurement and binding of a contaminant, such as arsenic or a heavy metal. In some specific embodiments, acidified or non-acidified reverse osmosis water may be used to wash the composition. Any amount of acidified or non-acidified RO water may be used as necessary to remove the contaminants or other elements from the adsorbent composition or column, including 5 mL, 10 mL, 15 mL, 20 mL, 25 mL, 30 mL, or the like. Any appropriate volume may be used, and any number of washes may be performed, as would be understood by one of skill in the art.

In accordance with the invention, a method as described herein may further comprise a step of analyzing the filtered fluid after filtration in order to determine the concentration of contaminant. Any method appropriate for determining the presence or concentration of a particle or component of a solution may be used, including, but not limited to scanning electron microscopy (SEM), mass spectrometry, such as inductively coupled plasma mass spectrometry, Raman spectroscopy, and any other methods known in the art. The application and particular contaminant will determine the appropriate testing methods and/or analysis methods to be used.

In some particular embodiments, the organically modified inorganic adsorbent material may be used to prepare a column for filtration of a fluid sample. Any number of samples may be analyzed with such a method, and any number of analyses may be performed. The longevity and durability of the compositions described herein may enable a large number of filtrations to be performed with no reduction in the sensitivity or specificity of the composition, or a column comprising such a composition.

### Research Objectives for Adsorbent Material

The present disclosure provides analysis and characterization of a novel adsorbent material that exhibits selectivity for arsenic and heavy metals such as uranium, is durable under many different conditions, and is reusable for long periods, resulting in lower cost for the consumer. Successful characterization and development of these filters will have a large impact on small water systems and individual homes. Many places with arsenic or heavy metal contamination, for example either by natural sources or mine-waste runoff, do not have the financial capacity or accessibility to electricity required to utilize current filtration systems. Current methods for arsenic or heavy metal removal include finding new sources of water, mixing sources of water to dilute concentrations, and building specific treatment plants, using, for example, ion exchange or reverse osmosis systems (11). However, there are places in which none of these options are possible, for example the Navajo Nation and other remote places, where group water supplies and/or electricity are not readily available. In addition, the option that is most feasible, the ion exchange approach, is not specific for uranium, for example, so when competing ions like calcium and magnesium are present, the filter material may not capture uranium (11). Furthermore, these systems are very pH dependent. The adsorbent material of the present invention is designed to be more pH independent.

### Definitions

As used herein, “adsorbent” or “adsorbent material” or “adsorbent compound” refers to an organically-modified material (e.g., graphite, silica, alumina, titanium oxide, or transition metal particles) that adsorbs arsenic, uranium, vanadium, iron, zinc, strontium, tin, palladium, copper, silver, gold, or barium, in the filtrate (fluid) going past the adsorbent filter, i.e., the material which adsorbs to and acts like a filter.

As used herein, “cycloaddition” or “cyclo addition” refers to a chemical reaction in which two or more unsaturated molecules, or parts of the same molecule, combine with the formation of a cyclic adduct in which there is a net reduction of the bond multiplicity. May also be referred to as a cyclization reaction.

### EXAMPLES

In order to evaluate the present adsorbent material for heavy metal capture using uranium for validation, chromatographic studies were performed using an Agilent 7900 Inductively Coupled Mass Spectrometer, in order to analyze samples separated using columns made from a novel adsorbent material. Both laboratory samples and natural water samples were used for analysis. The adsorbent material was further characterized via adsorption capacity, adsorption percentage, and scanning electron microscopy. Laboratory samples of 30 ppb uranium and 50 ppb uranium, calcium, and magnesium were injected onto columns of adsorbent material in Pasteur pipettes. The percent absorption calculated from these results suggested that one material (CM1) exhibited the highest percent uranium absorption and selectivity towards uranium over other common divalent cations. Naturally contaminated water sources were analyzed in the same manner at pH of 8.5 and 1.5 in order to determine the material's pH dependence and ability to capture uranium in a complex system.

CM1 showed the best selectivity, reproducibility, and higher degree of metal adsorption over all other adsorbent or filter materials analyzed, with over 95% uranium adsorbed and a 60% absorption increase of uranium over calcium and magnesium. In natural samples, it also showed higher uranium selectivity over calcium and magnesium, as well as other metals at pH 1.5 with above 60% uranium absorption. Natural samples with a pH of 8.5 showed higher uranium absorption and high selectivity towards uranium over most other metals at pH 8.5. The material also showed high chemical stability against strong acids. This allowed full metal recovery without losing selectivity for uranium or the capacity for uranium adsorption. This stability against strong acids will also benefit consumers because the acid can be sterilized against biological contaminations.

The present study demonstrates that the CM1 adsorbent material has high specificity for the absorption of uranium in natural water samples. It further suggests that other metals that often interfere with uranium absorption have less effect. Further optimization will enable the CM1 adsorbent material to be used for development of a low-cost commercial uranium filter.

### Example 1

### Column Description

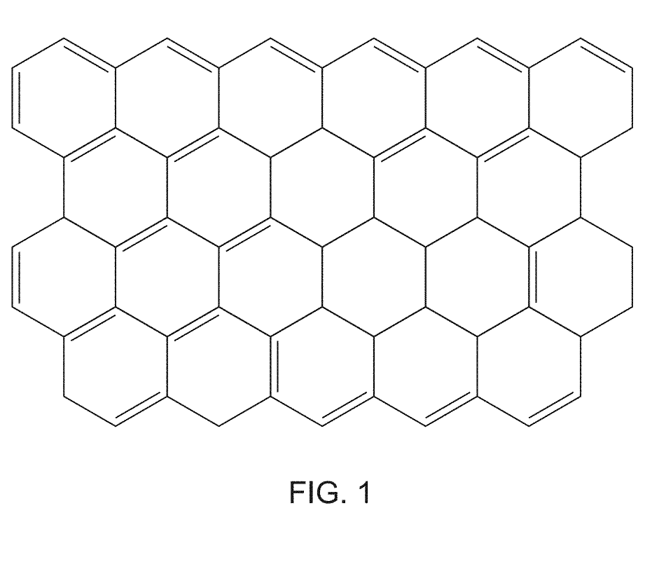

Several columns were developed for these tests with two different types of starting materials. Starting material SC was a graphite powder (FIG. 1) named “commercial” graphite because it was purchased from Sigma-Aldrich.

The commercial-grade graphite powder SC was heated with tetracyanoethylene oxide for 48 hours in chlorobenzene at 150-160° C. In these conditions, tetracyanoethylene oxide converts into very reactive 1,3-carbonyl ylide, which can react with graphite. Then the obtained organically modified graphite CM1 was washed over a filter by water, alcohol, acetonitrile, and acetone, and then dried overnight. The success of modification was confirmed by Raman spectroscopy.

To determine the effectiveness of uranium adsorption and selectivity versus the amount of adsorbent material present, the SC and CM1 materials were developed into two columns, each with weights of 75 mg and 500 mg material. Each column system was a Pasteur pipette with a cotton stopper packed with test material. Table 1 provides column descriptions and abbreviations.

As a starting material, a number of materials other than graphite powder were contemplated for use. Additional starting materials may include, but are not limited to, alumina oxide, titanium oxide, silica dioxide and related materials as well as a variety of metallic particles.

TABLE 1
Column Names and Explanations.

| | Abbrevia- | |
|---|---|---|
| Column Names | tions | Starting Material |
| Starting Commercial 75 | SC 75 | Commercial graphite from Sigma |
| Modification 1 | CM1 75 | Commercial graphite from Sigma |
| Commercial 75 | | |
| Starting Commercial 500 | SC 500 | Commercial graphite from Sigma |
| Modification 1 | CM1 500 | Commercial graphite from Sigma |
| Commercial 500 | | |

All experiments for columns CM1 75 and CM1 500 were performed by repeating each experiment on a washed column three times, whereas the modification of the same experiments for starting materials SC 75 and SC 500 was done by repeating the experiments on three fresh material column.

All columns were washed prior to use with 15 mL of acidified reverse osmosis (RO) water for all samples.

### Example 2

### Uranium Adsorption

To test the materials absorption ability, 30 ppb uranium solution was made from a stock solution of 1000 ppb single element ICP-MS standard of uranium in 2% nitric acid purchased by SPEX CertiPrep (cat# CLU2-1BY). A portion of 5 mL of 30 ppb uranium was injected onto each prewashed column with micropipettes and allowed to drain through. In some instances, pressure was applied with a pipette bulb to increase the flow rate of the liquid. Once the sample was added, each column was washed with 15 mL of acidified RO water between pH 1 and 2.

### Example 3

### Selectivity and Recovery of Uranium

A series of tests were performed to determine the selectivity of each test material to bind uranium over other common cations, such as calcium and magnesium. This was first done using laboratory samples. A 50-ppb solution of uranium, calcium, and magnesium was made from separate single-element standards purchased from SPEX CertiPrep in 2% nitric acid. This solution was named “50 ppb All Metal Mix.” A 5-mL aliquot of the All Metal Mix was injected onto each column using micropipettes and let drain through, again with some instances using pressure created by a pipette bulb. Each column was then washed with 15 or 20 mL of acidified RO water between pH 1 and 2. The quality of the cleaning procedure of each column was determined by ICP-MS and is described above. To look at the reproducibility of the selectivity of uranium over calcium and magnesium, this procedure was repeated two additional times on the same washed column.

### Example 4

### Wash Analysis

Using fresh test material for all columns, 5-mL portions of acidified RO water between pH 1 and 2 was injected onto the columns. These were analyzed on the ICP-MS to determine the amount of wash solution required to completely rid each column of calcium, magnesium, and uranium, to uranium limits significantly below EPA drinking water safety limits.

### Example 5

### Metal Adsorption in Natural Samples at Various pH Values

To determine the applications of the CM1 500 material with natural samples, two natural water samples were used; CVD (flowing water from Shiprock, New Mexico) with a pH of 8.5 and CVF (Stagnant pond water from Shiprock, New Mexico) with a pH of 8.6. The original concentrations of these samples were over 100 ppb uranium. Since the previous cleaning injections were between pH 1 and 2, additional injections of non-acidified RO water at a pH of about 6 were needed to increase the pH of the material before the natural water samples were injected to prevent metal species changing. This was done by monitoring the eluted water with a pH meter. The procedure was deemed complete when the pH was above 6. Once the material reached normal natural water pH levels (i.e., between 6-8), a sample of 5 mL of CVD was injected onto the column and allowed to elute. The column was then cleaned with three 5-mL portions of acidified RO water to remove all bound metals and then injected with three 5-mL portions of non-acidified RO water to increase the pH of the material for the next injection. Once the material was cleaned, 5 mL of CVF was then injected and washed as described. This was repeated two more times for each sample with cleaning and neutralizing washes between each sample.

To determine if the material adsorbs uranium from natural sources at lower pHs, the CVD sample was acidified with a few drops of concentrated nitric acid (15.8 M) and run through the columns again. It was desired to test the adsorbent material at multiple pH values to determine the validity of metal adsorption because it is common practice to preserve samples for trace-metal analysis with nitric acid. These samples were acidified to change the metal species to determine how well the material adsorbs uranium when it is present in multiple species and at different pH values. The pH was tested with pH paper and accepted if it was below pH 2. This allowed all of the sample and washing solutions to be in the same pH range. The column was washed with 3 portions of 5 mL of acidified RO water with a pH between 1 and 2. Five milliliters of the newly acidified natural sample CVD was then injected onto the column followed by 3 rinses of 5 mL of acidified RO water. This was repeated two more times with the same column.

### Example 6

### Adsorption Capacity

Using the CM1 500, a Langmuir Isotherm was created using a standard adsorption isotherm method form Langmuir (1997) (3). Fresh materials were split into ten portions of about ten milligrams and placed into individual test tubes. Ten milliliters of acidified RO water between pH 1 and 2 were placed in each test tube and shaken for ten minutes. Each test tube was then centrifuged at 4000 rpm for ten minutes and the supernatant was removed. A time test was done with 5 mL of 30 ppb uranium and shaken for two minutes at a time. Every two minutes, a sample was removed and analyzed for uranium concentration. Once the concentrations were consistent, the time of the last sample was used for further analysis, which was 6 minutes.

Next, concentrations of 1, 100, 500, 1000, 1500, 5000, 7500, 10000, 15000, and 20000 ppb uranium made from either the single element standard of uranium in 2% nitric acid for the first 4 concentrations or a solution made of uranium nitrate solid dissolved in water for the other 6 concentrations. The sample of 1 ppb uranium was chosen to determine if the material can adsorb small amounts of uranium, like found in the ocean. The highest value of 20 ppm was chosen because this was a common and high amount of uranium found in mine leachates. Five milliliters of each of these concentrations were placed in individual test tubes and marked to be able to associate the correct weight with the concentration and adsorption. Each test tube was shaken for 6 minutes and the supernatant was syringe-filtered with a 0.1μm filter. Dilutions of the highest seven concentrations were made using micropipettes, and all solutions were run through the ICP-MS. This experiment was done in triplicate.

### Example 7

### Scanning Electron Microscopy Imaging

Scanning electron microscopy images were taken and samples were analyzed with a standard SEM method. The Instrument used was a Hitachi S-3200N Scanning Electron Microscope set at 25 keV (kiloelectron volts). The electron detector was an Everheart Thornly.

### Example 8

### Uranium Adsorption

Table 2 provides data from the columns that were run to determine their percent uranium adsorption when only uranium was present. These adsorptions were based on a concentration of 30 ppb uranium single-element standard, which is the Environmental Protection Agency's drinking water limit for uranium consumption (11).

The SC 75 column had a 10% uranium adsorption, which was tripled to 30% when the amount of material present in the column was increased to 500 mg, shown in SC 500. The organic modification allowed increased uranium adsorption for the commercial material CM1 with 75 mg adsorbing between 40 and 50% uranium adsorption.

In the SC 500 column, the uranium adsorption increased, achieving 30% uranium adsorption. CM1 500 had 100% adsorption of uranium.

TABLE 2
Uranium adsorption raw percentages.

| | % Uranium | % Uranium | % Uranium |
|---|---|---|---|
| | Adsorbed | Adsorbed | Adsorbed |
| | Trial 1 | Trial 2 | Trial 3 |
| SC 75 | 34.00 | 4.41 | 1.12 |
| CM1 75 | 45.81 | 49.60 | 47.40 |
| SC 500 | 34.32 | 32.48 | 27.87 |
| CM1 500 | 99.99 | 91.46 | 97.99 |

### Example 9

### Selectivity and Recovery Towards Uranium

Table 3 provides the percent adsorption of each column based on a 50-ppb laboratory sample of each metal, nitrates of uranium, calcium, and magnesium in order to determine the amount of selective uranium binding of each over other common divalent cations.

Columns SC 75, CM1 75, CM1 75, SC 500 all showed no selectivity towards uranium and indicated higher calcium adsorption than uranium. CM1 500 showed greater than 90% uranium adsorption, with CMI 500 showing the best selectivity, with more than 60% increase of uranium adsorption over calcium and magnesium. Results are shown in Table 3.

TABLE 3
Multi-metal selectivity and recovery of uranium raw percentages.

| | % Calcium average | | | | % Magnesium average | | | | % Uranium Average | | | |
|---|---|---|---|---|---|---|---|---|---|---|---|---|
| SC 75 | 0.00 | 71.60 | 100.00 | 100.00 | 14.99 | 0.00 | 20.03 | 18.13 | 2.20 | 13.61 | 26.00 | 27.67 |
| CM1 75 | 14.98 | 100.00 | 100.00 | 79.95 | 3.40 | 0.00 | 26.06 | 16.86 | 39.57 | 44.60 | 47.11 | 33.32 |
| SC 500 | 18.14 | 62.57 | 100.00 | 100.00 | 0.32 | 0.00 | 34.40 | 35.00 | 29.34 | 21.28 | 41.76 | 40.36 |
| CM1 500 | 0.00 | 0.00 | 28.05 | 62.76 | 1.11 | 0.00 | 42.34 | 35.77 | 96.96 | 93.23 | 95.69 | 94.06 |

### Example 10

### Metal Adsorption in Natural Samples in Multiple pH Values

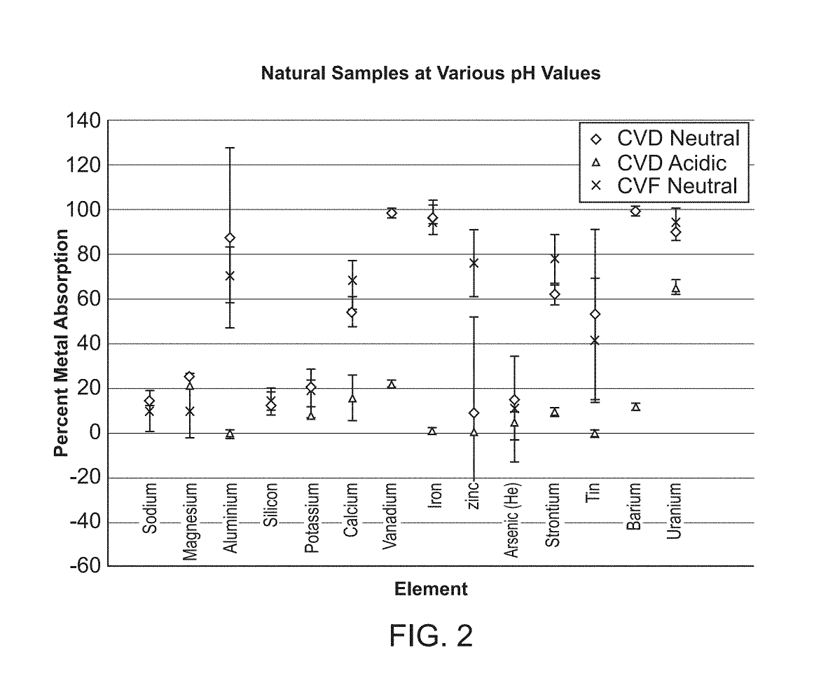

FIG. 2 shows results obtained using only the CM1 500 column. Note that arsenic was run on helium gas and all other metals used argon. The two neutral (pH 8.5) samples paralleled each other for percent adsorption of metals. Since more metals were present in these samples and many different species of each metal were present, the selectivity towards uranium changed. For magnesium, the selectivity towards uranium stayed about the same. Comparing the calcium adsorption to Table 3, a significant increase was seen in adsorption (by about 50%) with the natural samples over the laboratory samples, but a slight decrease was seen when the natural samples were acidified. The assumption is that this increased adsorption was largely due to the species of these metals at each pH. In these samples, each metal can be in various species, compared to Table 2, where the laboratory samples were all a nitrate species from the metals nitrate salt form. This material interacted with uranium in various ways, including hydrogen bonding, affinity, and size. With all of the metals being tested interacting with each other, or with compounds such as carbonates that are found in the water, the size of their complex changed and they became more effectively captured. This may explain the increased calcium adsorption. This size trend may also explain why some metals adsorb similar to uranium, for example barium. These elements are also very large and act similarly to uranium when their binding habits are analyzed. Aluminum, iron, and vanadium, however do not make large complexes. All of these metals with higher than 80% adsorption have another important aspect in common. All of them produce what are known as aqua-complexes, such as [V(H₂O)₆]²⁺, [Fe(H₂O)₆]²⁺, [Al(H₂O)₆]³⁺, with aluminum forming other acids in the presence of water (13). This makes all metals large species that mimic uranium, which also makes aqua complexes.

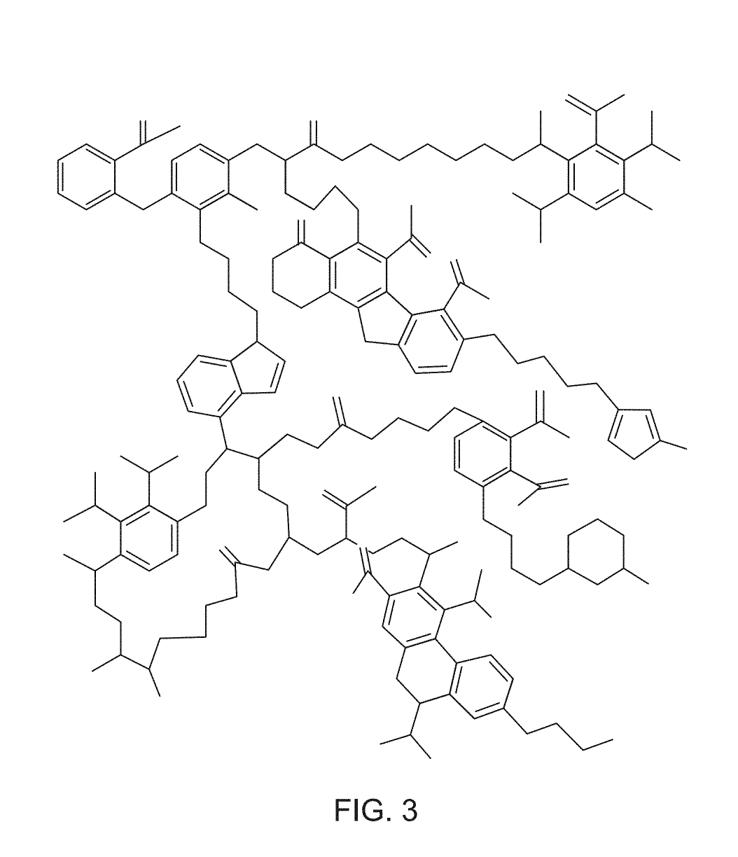

A positive result to note is the fact that in the two neutral samples, the uranium adsorption was still above 90%. In natural water, uranium was found to be strongly bound to humic acids, which are large globular plant breakdown matrices rich in carbons and oxygen (FIG. 3). Even in the acidic samples with decreased uranium adsorption, the material still showed greater than 60% uranium adsorption and selectivity towards the rest of the metals. This indicates that in a lab setting, with uranium being in a UO₂²⁺ form, or when it is highly bound to globular humic acids or other compounds, it still has a high capture percentage and selectivity. Table 4 provides raw capture percentages of a variety of elements in natural water samples for different pH values.

TABLE 4
Natural and pH dependence raw percentages.

| | CM1 500 with sample | | | CM1 500 with sample | | | CM1 500 with sample | | |
|---|---|---|---|---|---|---|---|---|---|
| Element | CVD (pH~8.5) | | | CVD (pH <2) | | | CVF (pH~8.5) | | |
| Sodium | 4.10 | 20.03 | 19.36 | 9.69 | 10.75 | 8.88 | 9.67 | 16.39 | 17.84 |
| Magnesium | 11.77 | 33.73 | 28.63 | 9.76 | 10.61 | 8.69 | 19.21 | 20.89 | 27.39 |
| Aluminum | 88.64 | 73.88 | 100.00 | 0.00 | 0.00 | 0.00 | 23.21 | 89.73 | 97.60 |
| Silicon | 6.32 | 17.87 | 15.48 | 11.58 | 13.23 | 11.88 | 7.97 | 16.93 | 17.20 |
| Potassium | 10.17 | 24.17 | 25.17 | 6.07 | 10.32 | 7.76 | 15.31 | 21.25 | 22.06 |
| Calcium | 59.63 | 57.06 | 44.40 | 2.51 | 20.04 | 22.13 | 62.95 | 76.17 | 66.51 |
| Vanadium (NG) | 95.91 | 100.00 | 100.00 | 21.05 | 22.58 | 21.52 | 96.46 | 100.00 | 100.00 |
| Iron | 88.59 | 100.00 | 100.00 | 2.96 | 0.00 | 0.00 | 86.04 | 100.00 | 100.00 |
| Zinc | 26.26 | 0.00 | 0.00 | 0.00 | 0.00 | 0.00 | 100.00 | 26.62 | 100.00 |
| Arsenic (He) | 0.00 | 41.02 | 0.00 | 15.38 | 0.00 | 0.00 | 0.00 | 30.00 | 0.00 |
| Strontium (NG) | 49.90 | 72.03 | 61.37 | 9.95 | 9.96 | 7.73 | 74.40 | 82.45 | 75.31 |
| Tin (NG) | 63.22 | 20.84 | 72.96 | 0.00 | 0.00 | 0.00 | 0.00 | 76.11 | 45.90 |
| Barium | 99.03 | 98.54 | 100.00 | 12.02 | 11.89 | 10.07 | 99.91 | 99.65 | 99.99 |
| Uranium | 93.77 | 93.09 | 82.80 | 60.36 | 67.13 | 65.57 | 92.41 | 98.96 | 90.63 |

### Example 11

### Adsorption Capacity

Low uranium concentrations were used to show the range of uranium the identified material was able to adsorb. Ocean water is usually found to be below 3 ppb uranium (17), and it is rare to find water with a higher concentration than 20 ppm. The distribution coefficient Kd is described as the binding of 85.24 mL of uranium in solution at a concentration of 15 ppm will bind to one gram of CM1 material.

Vaarnmaa et al. (18) reported ion exchange absorption capacities for acidic resins to have a Kd of 14 mL/g for metal-rich water, a Kd of 0 mL/g for good quality water, and a Kd of 44 mL/g for saline water. The Kd value, found to be directly comparable to the CM1 adsorption capacity of 85.24 mL/g and the water absorption of 0 mL/g, demonstrating that CM1 had a higher absorption capacity over acidified ion exchange resins. This confirms that ion exchange resins are pH dependent and that the CM1 material is more pH independent.

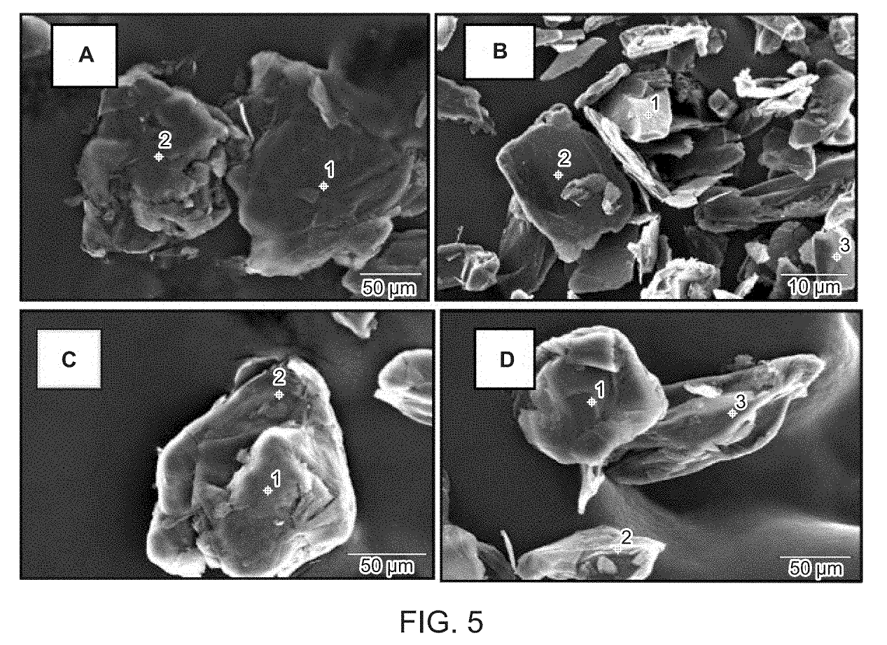

FIG. 5A-D show either unused or used commercial samples derived from starting commercial material. Analyzing the figures, it is visually apparent that the commercial samples (FIG. 5A-D) were all relatively smooth but had fractured surfaces. In the used samples (FIGS. 5B and D) there was no extra visible surface damage to indicate uranium, or any other metal, precipitating on the surface of the material. This suggested that the binding technique of the uranium was adsorption, and not precipitation. Also, it is important to note that the particle sizes varied largely throughout the sample. This is not as significant of a difference for the commercial samples.

Conclusions: Commercial modification 1 (CM1) material was the best material for adsorbent material for water remediation. The CM1 material showed the best selectivity, reproducibility, repeatability, and percent metal adsorption over all other columns made, with greater than 95% uranium adsorption and a selectivity towards uranium over calcium and magnesium of 60% in laboratory samples. In natural samples, CM1 also shows high uranium selectivity over calcium and magnesium, as well as other metals. CM1 exhibited a high adsorption capacity at 15 ppm uranium. CM1 material also showed high chemical stability against strong acids, which allowed full metal recovery without losing the material's subsequent selectivity towards uranium or capacity for uranium adsorption. The stability against strong acids provides a benefit to consumers because the acid can be sterilized against biological contaminations. CM1 used in commercially produced filters is beneficial because of its binding capacity and low pressure needs for home systems.

Various modifications and variations of the described methods, compositions, and systems of the invention will be apparent to those skilled in the art without departing from the scope and spirit of the invention. Although the invention has been described in connection with specific embodiments, it will be understood that it is capable of further modifications and that the invention as claimed should not be unduly limited to such specific embodiments. Indeed, various modifications of the described modes for carrying out the invention that are obvious to those skilled in the art are intended to be within the scope of the invention. This application is intended to cover any variations, uses, or adaptations of the invention following, in general, the principles of the invention and including such departures from the present disclosure come within known customary practice within the art to which the invention pertains and may be applied to the essential features herein before set forth.

### REFERENCES CITED

1. World Nuclear Association. Uranium Mining Overview. world-nuclear.org/info/Nuclear-Fuel-Cycle/Mining-of-Uranium/Uranium-Mining-Overview/#.UnK9XhCzKOg (accessed Oct. 31, 2013).
2. Maynard, B. J. Geochemistry of Sedimentary Ore Deposits. Springer-verlag; New York, 1983.
3. Langmuir, D.; Aqueous Environmental Geochemistry. Prentice-Hall Inc. 1997, 486-557.
4. Environmental Protection Agency. National primary drinking water standards for radionuclides, proposed rule, June, 1991. EPA Fact Sheet, Radionuclide's in Drinking water, 1991,570/9-91-700.
5. Fix, P. G. Hydrochemical exploration for uranium. U.S. Geol. Survey Prof Paper. 1956, 300, 667-71.
6. Langmuir, D.; D. K. The geochemistry of uranium mill tailings: An acid mine drainage problem, Unpublished MS Thesis, Nordstrom, 1995.
7. Pearcy, E. C.; Prikryl, J. D.; Murphy, W. M.; Leslie, B. W. Alteration of uraninile from the Napa! I deposit, Pena Blanca District. Chihuahua, Mexico. compared to degradation of spent nuclear fitel in the proposed U.S. high-level nuclear waste repository at Yucca Mountain, Nevada. Applied Geochem. 1994, 6, 713-732.
8. Bednar, A. J.; Medina, V. F.; Ulmer-Scholle, D. S.; Frey, B. A.; Johnson, B. I.; Brostoff, W. N.; Larson, S. I., Effects of organic matter on the distribution of uranium in soil and plant matrices. Chemosphere 2007, 70(2), 237-247.
9. Berto, S.; Crea, F.; Daniele, P. G.; Gianguzza, A.; Pettignano, A.; Sammartano, S., Advances in the investigation of dioxouranium(VJ) complexes of interest for natural fluids. Coordination Chemistry Reviews 2012, 256 (1-2), 63-81.
10. Nord, G. L. Characteristics affine-grained black uranium ores by transmission electron microscopy. Short papers of the U.S. Geol. Survey, uranium, thorium, symp., ed J. A. Campbell. U.S. Geol. Survey Circ. 1997, 753, 29-31.
11. Katsoyiannis, I. A.; Zououlis, A. I. Removal of uranium from contaminated drinking water: a mini review of available treatment methods. Desalination and water treatment. 2013. 2915-2925.
12. Veliscek-Carolan, J.; Jolliffe, K. A.; Hanley, T. L., Selective Sorption of Actinides by Titania Nanoparticles Covalently Functionalized with Simple Organic Ligands. Acs Applied Materials & Interfaces 2013, 5 (22). 11984-11994.
13. Greenwood, N. N.; Earnshaw, A., Chemistry of the Elements second edition. Butterworth Heinemann, 1984, 224-1079.
14. Wanderlustmind humic acid structure. wanderlustmind com/2009/03/07/shilajit/. (accessed Jan 15, 2014).
15. Seko, N.; Katakai, A.; Tamada, M.; Kasai, N.; Takeda, H.; Sugo, T.; Saito, K., Aquaculture of Uranium in Seawater by a Fabric-Adsorbent Submerged System. Nucl. Technol. 2003, 1.f-f., 274-278.
16. Osmio, Pure Pro Euro design water filter tap faucet. osmiowater.co.uk/pure-pro-euro-design-water-filter-tap-faucet.html. (Accessed Jun. 8, 2015).
17. North Star Water Conditioning, Commercial Heavy duty water filter. northstarconditioning.com/commercial-products/water-filter-system-2-valve/specifications/. (Accessed Jun. 8, 2015).
18. Vaaramaa K.; Lehto, J.; Jaakkola, T. Removal of ^{234,238}U, ²²⁶Ra, ²¹⁰Pa and ¹⁰Pb from drinking water by ion exchange. Radiochim. 2000. 88, 361-367.

What is claimed is:

1. A composition for fluid filtration comprising an organically modified inorganic adsorbent, wherein the organic modification of inorganic adsorbent is produced by reaction with one or more 1,3-dipolar compounds prior to filtration.

2. The composition of claim 1, wherein the inorganic adsorbent comprises graphite, silica, alumina, titanium oxide, or transition metal particles.

3. The composition of claim 2, wherein the contacting produces the organically modified inorganic adsorbent after reaction with the one or more 1,3-dipolar compounds prior to filtration.

4. The composition of claim 3, wherein the one or more 1,3-dipolar compounds comprise azomethyn ylides, nitrile ylides, carbonyl ylides, or thiosulfines.

5. The composition of claim 1, wherein the organically modified inorganic adsorbent is washed over a filter and then dried overnight, or used immediately.

6. The composition of claim 5, wherein the organically modified inorganic adsorbent is washed with one or more different organic and inorganic solvents.

7. The composition of claim 1, wherein the composition adsorbs contaminants in a fluid sample to remove the contaminants from the sample.

8. The composition of claim 1, wherein the fluid sample is water and the contaminant is a heavy metal or arsenic.

9. The composition of claim 8, wherein the heavy metal comprises uranium, vanadium, iron, zinc, strontium, tin, palladium, copper, silver, gold, or barium.

10. The composition of claim 8, wherein the fluid sample is drinking water, seawater, or freshwater.

11. The composition of claim 10, wherein the fluid sample has an acidic pH, a basic pH, or a neutral pH.

12. The composition of claim 8, wherein the composition binds to the heavy metal independent of pH of the fluid sample.

13. The composition of claim 8, wherein the composition binds to the heavy metal with greater selectivity than other compounds or elements present in the fluid sample.

14. A system for fluid filtration, comprising the composition of claim 1, wherein the composition binds to contaminants in a fluid sample to remove the contaminants from the sample.

15. The system of claim 14, wherein the fluid is water and the contaminant comprises uranium, vanadium, iron, zinc, arsenic, strontium, tin, palladium, copper, silver, gold, or barium.

16. The system of claim 14, wherein the fluid sample is drinking water, seawater, or freshwater.

17. The system of claim 14, wherein the fluid sample has an acidic pH, a basic pH, or a neutral pH.

18. The system of claim 14, wherein the composition binds to a heavy metal independent of pH of the fluid sample.

19. A method for fluid filtration, comprising:
contacting a fluid sample with the composition of claim 1; and
collecting the filtered fluid sample after filtration.

20. The method of claim 19, wherein the composition is contained within a column or permeable reservoir.

21. The method of claim 19, wherein the composition binds to contaminants in a fluid sample to remove the contaminants from the sample.

22. The method of claim 19, wherein the fluid sample is water and the contaminant comprises uranium, vanadium, iron, zinc, arsenic, strontium, tin, palladium, copper, silver, gold, or barium.

23. The method of claim 19, wherein the fluid sample is drinking water, seawater, or freshwater.

24. The method of claim 19, wherein the fluid sample has an acidic pH, a basic pH, or a neutral pH.

25. The method of claim 19, wherein the composition binds to arsenic or a heavy metal independent of pH of the fluid sample.
